(19) United States
(12) Patent Application Publication
(10) Pub. No.: US 2026/0155144 A1
(43) Pub. Date: Jun. 4, 2026

(54) SPEECH REPLY METHOD, AND ELECTRONIC DEVICE

(71) Applicant: Beijing Zitiao Network Technology Co., Ltd., Beijing (CN)

(72) Inventors: Jinbo XUE, Beijing (CN); Xinyu LI, Beijing (CN); Wei CAI, Beijing (CN)

(21) Appl. No.: 19/318,667

(22) Filed: Sep. 4, 2025

(30) Foreign Application Priority Data
Dec. 2, 2024 (CN) 202411756307.4

(51) Int. Cl. G10L 15/22; G06V 10/70; G06V 10/94; G10L 15/183; G10L 15/30; H04R 1/10

(52) U.S. Cl. CPC G10L 15/22; G06V 10/70; G06V 10/95; G10L 15/183; G10L 15/30; H04R 1/1016; H04R 1/1041

(57) ABSTRACT

Embodiments of the present disclosure provide a speech reply method, and an electronic device, and relates to the field of computer technologies. The method includes: obtaining inquiry speech information in response to an earphone being in an earphone case; controlling a camera provided on the earphone to capture a first image; obtaining first reply speech information for the inquiry speech information, where the first reply speech information is information related to the first image, and the first image and the inquiry speech information are processed by a pre-trained dialogue model to obtain the first reply speech information; and playing the first reply speech information.

### CROSS-REFERENCE TO RELATED APPLICATIONS

The present disclosure is based on and claims priority of CN Patent Application No. 202411756307.4 filed on Dec. 2, 2024, the disclosure of which is hereby incorporated by reference in its entirety.

### TECHNICAL FIELD

Embodiments of the present disclosure relate to the field of computer technologies, and in particular, to a speech reply method, and an electronic device.

### BACKGROUND

Intelligent dialogue is a type of interaction between users and smart devices implemented in a question-and-answer mode, where intelligent dialogue is widely applied in scenarios such as speech assistants and intelligent customer service.

Currently, intelligent dialogue is mainly implemented through terminal devices. For example, a user inputs speech information or text information through an interface of a terminal device, and the terminal device outputs corresponding reply information.

### SUMMARY

In a first aspect, an embodiment of the present disclosure provides a speech reply method, which is applied to an earphone case. The speech reply method includes: obtaining inquiry speech information in response to an earphone being in the earphone case; controlling a camera provided on the earphone to capture a first image; obtaining first reply speech information for the inquiry speech information, where the first reply speech information is information related to the first image, and the first image and the inquiry speech information are processed by a pre-trained dialogue model to obtain the first reply speech information; and playing the first reply speech information.

In a second aspect, an embodiment of the present disclosure provides an earphone case. The earphone case includes:
an obtaining unit configured to obtain inquiry speech information in response to an earphone being in the earphone case;
a control unit configured to control a camera provided on the earphone to capture a first image;
a processing unit configured to obtain first reply speech information for the inquiry speech information, where the first reply speech information is information related to the first image, and the first image and the inquiry speech information are processed by a pre-trained dialogue model to obtain the first reply speech information; and
a playback unit configured to play the first reply speech information.

In a third aspect, an embodiment of the present disclosure provides an earphone system. The earphone system includes an earphone and an earphone case, where a camera is carried on the earphone, and the earphone case is configured to:
capture inquiry speech information in response to the earphone being in the earphone case;
control the camera provided on the earphone to capture a first image;
obtain first reply speech information for the inquiry speech information, where the first reply speech information is information related to the first image, and the first image and the inquiry speech information are processed by a pre-trained dialogue model to obtain the first reply speech information; and
play the first reply speech information.

In a fourth aspect, an embodiment of the present disclosure provides an electronic device. The electronic device includes: a processor and a memory, where
the memory stores computer-executable instructions, and
the processor executes the computer-executable instructions stored in the memory, to cause the processor to perform the speech reply method according to the first aspect and various possibilities of the first aspect.

In a fifth aspect, an embodiment of the present disclosure provides a computer-readable storage medium storing computer-executable instructions that, when executed by a processor, cause the speech reply method according to the first aspect and various possibilities of the first aspect to be implemented.

In a sixth aspect, an embodiment of the present disclosure provides a computer program product including a computer program that, when executed by a processor, causes the speech reply method according to the first aspect and various possibilities of the first aspect to be implemented.

### BRIEF DESCRIPTION OF THE DRAWINGS

To describe the technical solutions in embodiments of the present disclosure or in the related art more clearly, the accompanying drawings for describing the embodiments or the related art are briefly described below. Apparently, the accompanying drawings in the following description are some embodiments of the present disclosure, and those of ordinary skill in the art may still derive other accompanying drawings from these accompanying drawings without creative efforts.

FIG. 1 is a schematic diagram of an application scenario of a speech reply method according to an embodiment of the present disclosure;

FIG. 2 is a flowchart of a speech reply method according to an embodiment of the present disclosure;

FIG. 3 is a flowchart of another speech reply method according to an embodiment of the present disclosure;

FIG. 4 is a schematic structural diagram of an earphone device according to an embodiment of the present disclosure; and

FIG. 5 is a schematic structural diagram of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure are described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It can be understood that before the use of the technical solutions disclosed in the embodiments of the present disclosure, a target user shall be informed of the type, range of use, use scenarios, etc., of personal information involved in the present disclosure in an appropriate manner in accordance with the relevant laws and regulations, and the authorization of the target user shall be obtained.

It can be understood that the above-mentioned process of notifying and obtaining the authorization of the target user is only illustrative and does not constitute a limitation on the implementations of the present disclosure, and other manners that satisfy the relevant laws and regulations may also be applied in the implementations of the present disclosure.

The present disclosure provides a speech reply method, which is implemented by: obtaining inquiry speech information in response to an earphone being in an earphone case; controlling a camera provided on the earphone to capture a first image; obtaining first reply speech information for the inquiry speech information, where the first reply speech information is information related to the first image, and the first image and the inquiry speech information are processed by a pre-trained dialogue model to obtain the first reply speech information; and playing the first reply speech information. In this way, in the case where the earphone is in the earphone case, the earphone case can implement the intelligent dialogue with the user based on the first image captured through the earphone, thereby improving the intelligent dialogue efficiency in the scenario where the earphone is in the earphone case.

It should be noted that the speech reply method provided in the present disclosure can be applied to any earphone case configured with an intelligent dialogue function.

The speech reply method provided in the embodiments of the present disclosure will be described below in detail with reference to the accompanying drawings.

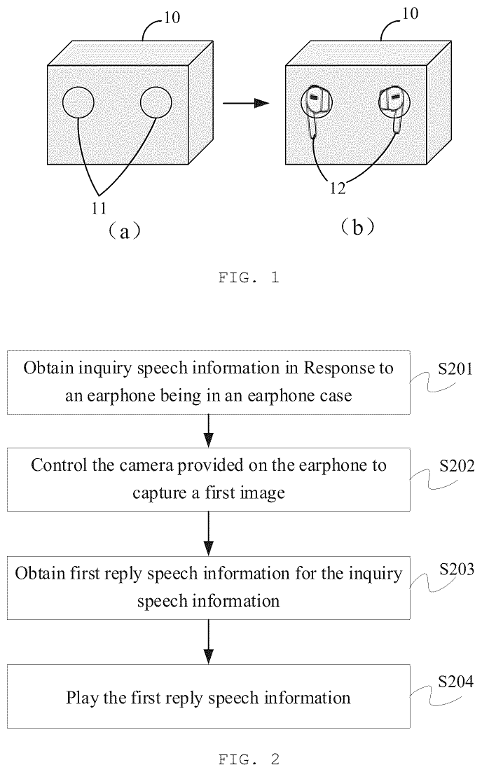

FIG. 1 is a schematic diagram of an application scenario of a speech reply method according to an embodiment of the present disclosure. As shown in FIG. 1, an earphone case 10 is provided with through holes 11, and a camera is carried on the earphones 12. When the earphones 12 are placed in the earphone case 10, the camera on the earphones 12 can capture images of a scene outside the earphone case through the through holes. Therefore, the earphone case 10 can implement intelligent dialogue with a user based on the images captured by the earphones 12.

FIG. 1 is merely an exemplary application scenario which may be implemented with any earphone case configuration, and the type of the earphone case is not limited in the present disclosure.

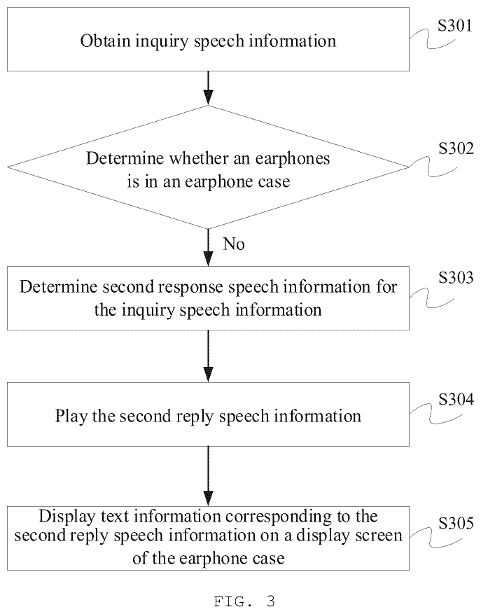

FIG. 2 is a flowchart of a speech reply method according to an embodiment of the present disclosure. The speech reply method is applied to an earphone case and may include the following steps.

In step S201, inquiry speech information is obtained in response to an earphone being in the earphone case.

In the embodiment of the present disclosure, with reference to FIG. 1, the earphone case can detect whether the earphone is in the earphone case, and in a case where the earphone is in the earphone case, the earphone case can obtain the inquiry speech information of a user.

It can be understood that the earphone case is configured with a microphone for obtaining the inquiry speech information of the user.

In addition, the earphone case has conventional functions of the earphone case, like holding and charging earphones.

Further, the earphone case is provided with the microphone, a speaker, a processor, and a display screen, etc. The earphone case may function as an electronic device to communicate with another electronic device.

In step S202, the camera provided on the earphone is controlled to capture a first image.

In the embodiment of the present disclosure, the earphone is provided with the camera to capture images of the surrounding scenes.

Further, in a case where the user wears the earphone, the camera may be turned on to capture one or more frames of images of scenes around the user. In addition, the earphone may capture the inquiry speech information of the user. The images and the inquiry speech information are then input into a pre-trained dialogue model for processing to obtain reply speech information, which is played through the earphone.

In one embodiment, the pre-trained dialogue model may be deployed on the earphone side. The earphone may directly input the images and the inquiry speech information into the dialogue model for processing to obtain the reply speech information for playback.

In another embodiment, the dialogue model is deployed on a terminal device (e.g., a mobile phone). The earphone may send the images and the inquiry speech information to the terminal device, which inputs the images and the inquiry speech information into the dialogue model for processing to obtain the reply speech information. Then, the terminal device sends the reply speech information to the earphone for playback.

In still another embodiment, the dialogue model may be deployed at the cloud. The earphone may connect to a network to send the images and the inquiry speech information to the dialogue model at the cloud for processing to obtain the reply speech information for playback.

It can be understood that, in a case where the earphone in the present disclosure is not in the earphone case and is worn by the user, the earphone can independently implement the intelligent dialogue. In addition, the earphone can detect whether the earphone is in a worn state. In a case where the earphone is in the worn state, the earphone may directly transmit the captured images to the terminal device for processing or storage.

Furthermore, in the present disclosure, a camera may be provided on one of the earphones, with the camera capturing the first image, or a camera may be provided on each of the two earphones, with the two cameras each capturing a first image.

In the present disclosure, in a case where the earphone is in the earphone case, the camera on the earphone is controlled by the earphone case, and the earphone case can control the camera on the earphone to capture the first image.

In step S203, first reply speech information for the inquiry speech information is obtained.

The first reply speech information is information related to the first image, and the first image and the inquiry speech information are processed by the pre-trained dialogue model to obtain the first reply speech information.

The dialogue model is an LLM (large language model), and the dialogue model is a pre-trained multi-modal language model that can process the first image and the inquiry speech information in natural language to obtain the first reply speech information. The first reply speech information is information related to the first image. For example, in a case where the inquiry speech information is “XX, what is next to the car?”, where “XX” is a wake-up word, and the first image includes “a car and a tree next to the car”, the first reply speech information may be “There is a tree next to the car.” In a case where the inquiry speech information is “What kind of tree is this?”, the first reply speech information may be “This is a willow tree.”

In the embodiment of the present disclosure, the input to the dialogue model may be the inquiry speech information in a speech format; alternatively, the inquiry speech information may be converted into inquiry text information through an STT (speech to text) technique, the inquiry text information may be input to the dialogue model which outputs first reply text information, and the earphone device use a TTS (text to speech) technique to convert the first reply text information from a text format into the speech format to obtain the first reply speech information.

In one embodiment, obtaining the first reply speech information for the inquiry speech information includes: receiving the first image transmitted from the earphone; and inputting the first image and the inquiry speech information into the pre-trained dialogue model for processing to obtain the first reply speech information for the inquiry speech information.

It can be understood that the earphone transmit the first image captured by the camera to the earphone case, the earphone case is deployed with the dialogue model, and the earphone case can directly input the first image and the inquiry speech information into the dialogue model for processing to obtain the first reply speech information.

Alternatively, a dialogue application may be installed on the earphone case, and the dialogue model may be deployed on a cloud server. In this case, the earphone case may upload the first image and the inquiry speech information through the dialogue application to the dialogue model on the cloud server for processing to obtain the first reply speech information. The earphone case may directly connect to the network through Wi-Fi (a mobile hotspot) or an eSIM (embedded subscriber identity module) to upload the first image and the inquiry speech information to the dialogue model on the cloud server for processing.

In one embodiment, obtaining the first reply speech information for the inquiry speech information includes: receiving the first image transmitted from the earphone; and sending the first image and the inquiry speech information to a terminal device, where the terminal device is configured to process the first image and the inquiry speech information through the pre-trained dialogue model, to obtain the first reply speech information for the inquiry speech information; and receiving the first reply speech information sent from the terminal device.

It can be understood that the dialogue model is deployed on the terminal device side; therefore, the earphone case sends the first image and the inquiry speech information to the terminal device, and the terminal device processes the first image and the inquiry speech information through the dialogue model to obtain the first reply speech information.

In another embodiment, obtaining the first reply speech information for the inquiry speech information includes:
transmitting the inquiry speech information to the earphone; and
receiving the first reply speech information transmitted from the earphone, where the earphone is configured to process the first image and the inquiry speech information through the pre-trained dialogue model, to obtain the first reply speech information for the inquiry speech information.

It can be understood that the dialogue model is deployed on the earphone side; therefore, the earphone case sends the inquiry speech information to the earphone after obtaining the inquiry speech information, and the earphone inputs the inquiry speech information and the captured first image into the dialogue model for processing to obtain the first reply speech information, and then transmits the first reply speech information to the earphone case for playback.

In conclusion, the present disclosure can adopt a variety of approaches to process the first image and the inquiry speech information through the dialogue model to obtain the first reply speech information.

In step S204, the first reply speech information is played.

In the embodiment of the present disclosure, the method further includes: receiving at least one second image transmitted from the earphone, where the at least one second image is captured through the earphone outside the earphone case, and the at least one second image is an image stored in the earphone; and storing the at least one second image in the earphone case and controlling the at least one second image stored in the earphone to be deleted.

It can be understood that the earphone has a storage unit and the earphone case also has a storage unit, where the storage capacity of the storage unit of the earphone case is greater than the storage capacity of the storage unit of the earphone. Therefore, in a case where the earphone is worn, the second image captured by the earphone is first stored in the storage unit of the earphone, and in a case where the earphone is in the earphone case, the second image stored in the storage unit of the earphone may be transferred to the storage unit of the earphone case, and then the second image stored in the earphone is deleted to free up the storage unit of the earphone. Further, the earphone case may transmit the second image to the terminal device for storage via Wi-Fi, Bluetooth, or Type-C.

Further, text information corresponding to the first reply speech information is displayed on a display screen of the earphone case.

It can be understood that, in the embodiment of the present disclosure, the display screen may be deployed on the earphone case, and text information for speech information during the intelligent dialogue may be displayed on the display screen, thereby facilitating a user to more accurately receive reply content for the inquiry speech information.

Moreover, human-computer interaction can be implemented through the display screen, that is, the user can view images stored in the earphone case.

In the embodiment of the present disclosure, in a case where the earphone is not in the earphone case and is worn by the user, the user can perform the intelligent dialogue through the earphone. In a case where the earphone is in the earphone case, the user can perform the intelligent dialogue through the earphone case, thereby improving the intelligent dialogue efficiency.

In conclusion, after the earphone is placed in the earphone case, the camera of the earphone is exposed. A connection link between the earphone and the terminal device is disconnected, and the earphone first transmit the captured first image to the earphone case. The user speaks the inquiry speech information to the earphone case. The earphone case controls the camera on the earphone to capture the first image, and transmits the first image through the earphone case to the dialogue model. The earphone case obtains the inquiry speech information of the user and sends the inquiry speech information of the user to the dialogue model. The dialogue model processes the first image and the inquiry speech information to obtain the first reply speech information, and then informs the user of the first reply speech information through the earphone case. In this way, the intelligent dialogue is implemented with the earphone being in the earphone case.

FIG. 3 is a flowchart of a speech reply method according to an embodiment of the present disclosure. The method is applied to an earphone case, and specifically includes the following steps.

In step S301, inquiry speech information is obtained.

In the embodiment of the present disclosure, a microphone configured on the earphone case may obtain the inquiry speech information of a user.

In step S302, whether an earphone is in the earphone case is determined.

If yes, steps S201 to S204 are executed; or if no, step S303 is executed.

It can be understood that the earphone case can detect whether the earphone is in the earphone case, and in a case where the earphone is in the earphone case, the content shown in FIG. 2 may be executed to reply to the inquiry speech information of the user.

In step S303, second reply speech information for the inquiry speech information is determined.

The inquiry speech information is processed by a dialogue model to obtain the second reply speech information.

It can be understood that in a case where the earphone is not in the earphone case, the earphone case can independently process the inquiry speech information, that is, only the inquiry speech information is processed through the dialogue model.

For example, if the inquiry speech information is “What class do butterflies belong to?”, the obtained second reply speech information may be “Butterflies belong to the insect class.”

In step S304, the second reply speech information is played.

In the embodiment of the present disclosure, the second reply speech information may be played through a speaker on the earphone case.

In step S305, text information corresponding to the second reply speech information is displayed on a display screen of the earphone case.

It can be understood that the display screen may be deployed on the earphone case, and text information for speech information during the intelligent dialogue may be displayed on the display screen, thereby facilitating the user to more accurately receive reply content for the inquiry speech information.

In conclusion, the speech reply method provided in the present disclosure enables the intelligent dialogue with the user through the earphone when the user wears the earphone, or independently through the earphone case. When the user is not wearing the earphone, if the earphone is in the earphone case, the intelligent dialogue can be implemented through interaction between the earphone case and the earphone, thereby improving the intelligent dialogue efficiency and the user experience.

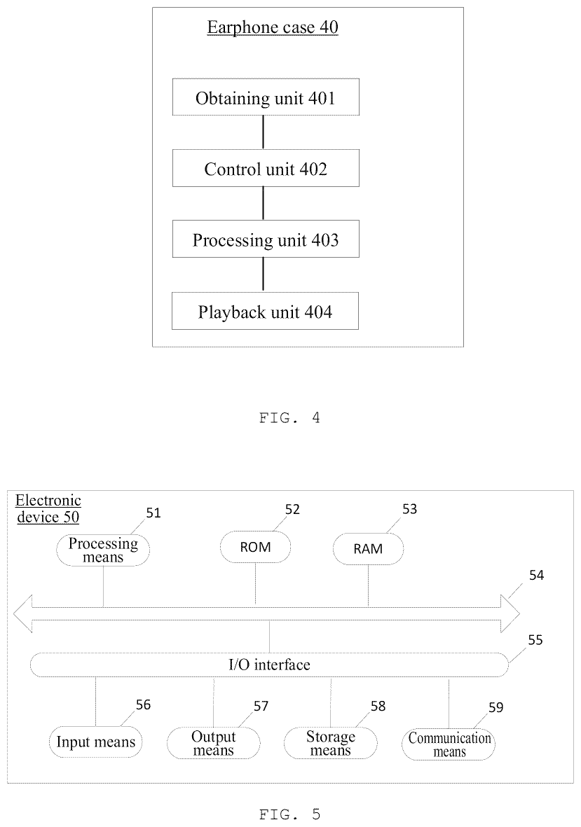

FIG. 4 is a schematic structural diagram of an earphone case according to an embodiment of the present disclosure. The earphone case 40 may include:
an obtaining unit 401 configured to obtain inquiry speech information in response to an earphone being in the earphone case;
a control unit 402 configured to control a camera provided on the earphone to capture a first image;
a processing unit 403 configured to obtain first reply speech information for the inquiry speech information, where the first reply speech information is information related to the first image, and the first image and the inquiry speech information are processed by a pre-trained dialogue model to obtain the first reply speech information; and
a playback unit 404 configured to play the first reply speech information.

In an alternative embodiment, the processing unit 403 is specifically configured to: receive the first image transmitted from the earphone; and input the first image and the inquiry speech information into the pre-trained dialogue model for processing to obtain the first reply speech information for the inquiry speech information.

In an alternative embodiment, the processing unit 403 is specifically configured to: receive the first image transmitted from the earphone; and
send the first image and the inquiry speech information to a terminal device, where the terminal device is configured to process the first image and the inquiry speech information through the pre-trained dialogue model, to obtain the first reply speech information for the inquiry speech information; and
receive the first reply speech information sent from the terminal device.

In an alternative embodiment, the processing unit 403 is specifically configured to: transmit the inquiry speech information to the earphone; and
receive the first reply speech information transmitted from the earphone, where the earphone is configured to process the first image and the inquiry speech information through the pre-trained dialogue model, to obtain the first reply speech information for the inquiry speech information.

In an alternative embodiment, the processing unit 403 is further configured to: determine, in response to the earphone being not in the earphone case, second response speech information for the inquiry speech information, where the inquiry speech information is processed by the dialogue model to obtain the second response speech information; and
the playback unit 404 is further configured to: play the second reply speech information.

In an alternative embodiment, the earphone case further includes:
a receiving unit (not shown) configured to receive at least one second image transmitted from the earphone, where the at least one second image is captured through the earphone outside the earphone case, and the at least one second image is an image stored in the earphone; and
the control unit 402 is further configured to store the at least one second image in the earphone case and controlling the at least one second image stored in the earphone to be deleted.

In another alternative embodiment, the earphone case further includes a display unit (not shown) configured to display text information corresponding to the first reply speech information on a display screen of the earphone case.

For the specific implementation process of the earphone case provided in the embodiments of the present disclosure, reference may be made to the speech reply method embodiments, and details are not described herein.

In addition, the present disclosure further provides an earphone system. The earphone system includes an earphone and an earphone case, where a camera is carried on the earphone, and the earphone case is configured to: capture inquiry speech information in response to the earphone being in the earphone case; control the camera provided on the earphone to capture a first image; obtain first reply speech information for the inquiry speech information, where the first reply speech information is information related to the first image, and the first image and the inquiry speech information are processed by a pre-trained dialogue model to obtain the first reply speech information; and play the first reply speech information.

For the specific implementation process of the earphone system provided in the embodiment of the present disclosure, reference may be made to the speech reply method embodiments, and details are not described herein.

In order to implement the above-mentioned embodiments, an embodiment of the present disclosure further provides a computer-readable storage medium storing computer-executable instructions that, when executed by the processor, cause the speech reply method according to any one of the above-mentioned embodiments to be implemented.

In order to implement the above-mentioned embodiments, an embodiment of the present disclosure further provides a computer program product including a computer program that, when executed by the processor, causes the speech reply method according to any one of the above-mentioned embodiments to be implemented.

In order to implement the above-mentioned embodiments, an embodiment of the present disclosure further provides an electronic device. The electronic device includes: a processor and a memory, where
the memory stores computer-executable instructions, and
the processor executes the computer-executable instructions stored in the memory, to cause the processor to perform the speech reply method according to any one of the above-mentioned embodiments.

FIG. 5 is a schematic structural diagram of an electronic device according to an embodiment of the present disclosure. The electronic device 50 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 5 is merely an example, and shall not impose any limitation on the function and scope of use of the embodiments of the present disclosure.

As shown in FIG. 5, the electronic device 50 may include a processing means (for example, a central processing unit or a graphics processing unit) 51 that may perform a variety of appropriate actions and processing based on a program stored in a read-only memory (ROM) 52 or a program loaded from a storage means 58 into a random access memory (RAM) 53. The RAM 53 further stores various programs and data required for the operation of the electronic device 50. The processing means 51, the ROM 52, and the RAM 53 are connected to one another through a bus 54. An input/output (I/O) interface 55 is also connected to the bus 54.

Generally, the following means may be connected to the I/O interface 55: an input means 56 including, for example, a touchscreen, a touchpad, a keyboard, a mouse, at least one camera, a microphone, an accelerometer, and a gyroscope; an output means 57 including, for example, a liquid crystal display (LCD), a speaker, and a vibrator; the storage means 58 including, for example, a magnetic tape and a hard disk drive; and a communication means 59. The communication means 59 may allow the electronic device 50 to perform wireless or wired communication with other devices to exchange data. Although FIG. 5 shows the electronic device 50 having various means, it should be understood that it is not required to implement or have all of the shown means. It may be an alternative to implement or have more or fewer means.

In particular, according to the embodiments of the present disclosure, the process described above with reference to the flowchart may be implemented as a computer software program. For example, an embodiment of the present disclosure includes a computer program product, which includes a computer program carried on a computer-readable medium, where the computer program includes program code for performing the methods shown in the flowcharts. In such an embodiment, the computer program may be downloaded and installed from a network through the communication means 59, installed from the storage means 58, or installed from the ROM 52. When the computer program is executed by the processing means 51, the above-mentioned functions defined in the method of the embodiments of the present disclosure are performed.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk drive, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The computer-readable medium may be included in the above-mentioned electronic device. Alternatively, the computer-readable medium may exist independently, without being assembled into the electronic device.

The computer-readable medium carries one or more programs that, when executed by the electronic device, cause the electronic device to perform the methods shown in the embodiments described above.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a target user, partially executed on a computer of a target user, executed as an independent software package, partially executed on a computer of a target user and partially executed on a remote computer, or completely executed on a remote computer or server. When a remote computer is involved, the remote computer may be connected to a computer of a target user through any type of network, including a local area network (LAN) or a wide area network (WAN), or may be connected to an external computer (for example, connected by using an Internet service provider through the Internet).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, a speech reply method, which is applied to an earphone case is provided. The speech reply method includes:
obtaining inquiry speech information;
controlling, in response to an earphone being in the earphone case, a camera provided on the earphone to capture a first image;
obtaining first reply speech information for the inquiry speech information, where the first reply speech information is information related to the first image, and the first image and the inquiry speech information are processed by a pre-trained dialogue model to obtain the first reply speech information; and
playing the first reply speech information.

According to one or more embodiments of the present disclosure, obtaining the first reply speech information for the inquiry speech information includes:
receiving the first image transmitted from the earphone; and
inputting the first image and the inquiry speech information into the pre-trained dialogue model for processing to obtain the first reply speech information for the inquiry speech information.

According to one or more embodiments of the present disclosure, obtaining the first reply speech information for the inquiry speech information includes:
receiving the first image transmitted from the earphone; and
sending the first image and the inquiry speech information to a terminal device, where the terminal device is configured to process the first image and the inquiry speech information through the pre-trained dialogue model to obtain the first reply speech information for the inquiry speech information; and
receiving the first reply speech information sent by the terminal device.

According to one or more embodiments of the present disclosure, obtaining the first reply speech information for the inquiry speech information includes:
transmitting the inquiry speech information to the earphone; and
receiving the first reply speech information transmitted from the earphone, where the earphone is configured to process the first image and the inquiry speech information through the pre-trained dialogue model to obtain the first reply speech information for the inquiry speech information.

According to one or more embodiments of the present disclosure, the method further includes:
determining, in response to the earphone being not in the earphone case, second response speech information for the inquiry speech information, where the inquiry speech information is processed by the dialogue model to obtain the second response speech information; and
playing the second reply speech information.

According to one or more embodiments of the present disclosure, the method further includes:
receiving at least one second image transmitted by the earphone, where the at least one second image is captured through the earphone outside the earphone case, and the at least one second image is an image stored in the earphone; and
storing the at least one second image in the earphone case and controlling the at least one second image stored in the earphone to be deleted.

According to one or more embodiments of the present disclosure, the method further includes: displaying text information corresponding to the first reply speech information on a display screen of the earphone case.

In a second aspect, according to one or more embodiments of the present disclosure, an earphone case is provided. The earphone case includes:
an obtaining unit configured to obtain inquiry speech information in response to an earphone being in the earphone case;
a control unit configured to control a camera provided on the earphone to capture a first image;
a processing unit configured to obtain first reply speech information for the inquiry speech information, where the first reply speech information is information related to the first image, and the first image and the inquiry speech information are processed by a pre-trained dialogue model to obtain the first reply speech information; and
a playback unit configured to play the first reply speech information.

In a third aspect, according to one or more embodiments of the present disclosure, an earphone system is provided. The earphone system includes an earphone and an earphone case, where a camera is carried on the earphone, and the earphone case is configured to:
capture inquiry speech information in response to the earphone being in the earphone case;
control the camera provided on the earphone to capture a first image;
obtain first reply speech information for the inquiry speech information, where the first reply speech information is information related to the first image, and the first image and the inquiry speech information are processed by a pre-trained dialogue model to obtain the first reply speech information; and
play the first reply speech information.

In a fourth aspect, according to one or more embodiments of the present disclosure, an electronic device is provided. The electronic device includes: at least one processor and a memory, where
the memory stores computer-executable instructions, and
the at least one processor executes the computer-executable instructions stored in the memory, to cause the at least one processor to perform the speech reply method according to the first aspect and various possible designs of the first aspect.

In a fifth aspect, according to one or more embodiments of the present disclosure, a non-transitory computer-readable storage medium is provided. The computer-readable storage medium stores computer-executable instructions that, when executed by the processor, cause the speech reply method according to the first aspect and various possible designs of the first aspect to be implemented.

In a sixth aspect, according to one or more embodiments of the present disclosure, a computer program product is provided. The computer program product includes the computer program that, when executed by the processor, causes the speech reply method according to the first aspect and various possible designs of the first aspect to be implemented.

In a sixth aspect, according to one or more embodiments of the present disclosure, an electronic device, comprising a processor and a memory, where:
the memory stores computer-executable instructions, and
the processor executes the computer-executable instructions stored in the memory, to cause the processor to perform the speech reply method comprising:
capturing, in response to a user wearing an earphone, an inquiry speech information of the user;
controlling a camera on the earphone to capture one or more frames of images of scenes around the user;
inputting the one or more frames of images and the inquiry speech information into a pre-trained dialogue model for processing to obtain a reply speech information;
playing the reply speech information through the earphone.

According to one or more embodiments of the present disclosure, the pre-trained dialogue model is deployed on the earphone.

According to one or more embodiments of the present disclosure, the pre-trained dialogue model is deployed on a terminal device, the earphone sends the one or more frames of images and the inquiry speech information to the terminal device to obtain the reply speech information, the reply speech information is obtained by the terminal device inputting the one or more frames of images and inquiry speech information into the pre-trained dialogue model, and the reply speech information is sent by the terminal device to the earphone for playback.

According to one or more embodiments of the present disclosure, the pre-trained dialogue model is deployed at the cloud, and the earphone sends the one or more frames of images and the inquiry speech information to the dialogue model at the cloud for processing to obtain the reply speech information for playback.

According to one or more embodiments of the present disclosure, the pre-trained dialogue model comprises a multi-modal language model.

According to one or more embodiments of the present disclosure, the inquiry speech information is converted into text information and input to the pre-trained dialogue model.

According to one or more embodiments of the present disclosure, the reply speech information is information related to the one or more frames of images.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned disclosed concept. For example, a technical solution formed by a replacement of the above-mentioned features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although a plurality of specific implementation details are included in the above-mentioned discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely example forms of implementing the claims.

What is claimed is:

1. A speech reply method, which is applied to an earphone case, the speech reply method comprising:
obtaining inquiry speech information;
controlling, in response to an earphone being in the earphone case, a camera provided on the earphone to capture a first image;
obtaining first reply speech information for the inquiry speech information, wherein the first reply speech information is information related to the first image, and the first image and the inquiry speech information are processed by a pre-trained dialogue model to obtain the first reply speech information; and
playing the first reply speech information.

2. The speech reply method according to claim 1, wherein obtaining the first reply speech information for the inquiry speech information comprises:
receiving the first image transmitted from the earphone; and
inputting the first image and the inquiry speech information into the pre-trained dialogue model for processing to obtain the first reply speech information for the inquiry speech information.

3. The speech reply method according to claim 1, wherein obtaining the first reply speech information for the inquiry speech information comprises:
receiving the first image transmitted from the earphone; and
sending the first image and the inquiry speech information to a terminal device, wherein the terminal device is configured to process the first image and the inquiry speech information through the pre-trained dialogue model to obtain the first reply speech information for the inquiry speech information; and
receiving the first reply speech information sent from the terminal device.

4. The speech reply method according to claim 1, wherein obtaining the first reply speech information for the inquiry speech information comprises:
transmitting the inquiry speech information to the earphone; and
receiving the first reply speech information transmitted from the earphone, wherein the earphone is configured to process the first image and the inquiry speech information through the pre-trained dialogue model, to obtain the first reply speech information for the inquiry speech information.

5. The speech reply method according to claim 1, further comprising:
determining, in response to the earphone being not in the earphone case, second reply speech information for the inquiry speech information, wherein the inquiry speech information is processed by the dialogue model to obtain the second reply speech information; and
playing the second reply speech information.

6. The speech reply method according to claim 1, further comprising:
receiving at least one second image transmitted from the earphone, wherein the at least one second image is captured by the earphone outside the earphone case, and the at least one second image is an image stored in the earphone; and
storing the at least one second image in the earphone case and controlling the at least one second image stored in the earphone to be deleted.

7. The speech reply method according to claim 1, further comprising: displaying text information corresponding to the first reply speech information on a display screen of the earphone case.

8. An electronic device, comprising a processor and a memory, wherein:
the memory stores computer-executable instructions, and
the processor executes the computer-executable instructions stored in the memory, to cause the processor to perform the speech reply method comprising:
obtaining inquiry speech information;
controlling, in response to an earphone being in an earphone case, a camera provided on the earphone to capture a first image;
obtaining first reply speech information for the inquiry speech information, wherein the first reply speech information is information related to the first image, and the first image and the inquiry speech information are processed by a pre-trained dialogue model to obtain the first reply speech information; and
playing the first reply speech information.

9. The electronic device according to claim 8, wherein obtaining the first reply speech information for the inquiry speech information comprises:
receiving the first image transmitted from the earphone; and
inputting the first image and the inquiry speech information into the pre-trained dialogue model for processing to obtain the first reply speech information for the inquiry speech information.

10. The electronic device according to claim 8, wherein obtaining the first reply speech information for the inquiry speech information comprises:
receiving the first image transmitted from the earphone; and
sending the first image and the inquiry speech information to a terminal device, wherein the terminal device is configured to process the first image and the inquiry speech information through the pre-trained dialogue model to obtain the first reply speech information for the inquiry speech information; and
receiving the first reply speech information sent from the terminal device.

11. The electronic device according to claim 8, wherein obtaining the first reply speech information for the inquiry speech information comprises:
transmitting the inquiry speech information to the earphone; and
receiving the first reply speech information transmitted from the earphone, wherein the earphone is configured to process the first image and the inquiry speech information through the pre-trained dialogue model, to obtain the first reply speech information for the inquiry speech information.

12. The electronic device according to claim 8, wherein the speech reply method further comprising:
determining, in response to the earphone being not in the earphone case, second reply speech information for the inquiry speech information, wherein the inquiry speech information is processed by the dialogue model to obtain the second reply speech information; and
playing the second reply speech information.

13. The electronic device according to claim 8, wherein the speech reply method further comprising:
receiving at least one second image transmitted from the earphone, wherein the at least one second image is captured by the earphone outside the earphone case, and the at least one second image is an image stored in the earphone; and
storing the at least one second image in the earphone case and controlling the at least one second image stored in the earphone to be deleted.

14. An electronic device, comprising a processor and a memory, wherein:
the memory stores computer-executable instructions, and
the processor executes the computer-executable instructions stored in the memory, to cause the processor to perform the speech reply method comprising:
capturing, in response to a user wearing an earphone, an inquiry speech information of the user;
controlling a camera on the earphone to capture one or more frames of images of scenes around the user;
inputting the one or more frames of images and the inquiry speech information into a pre-trained dialogue model for processing to obtain a reply speech information;
playing the reply speech information through the earphone.

15. The electronic device according to claim 14, wherein the pre-trained dialogue model is deployed on the earphone.

16. The electronic device according to claim 14, wherein the pre-trained dialogue model is deployed on a terminal device, the earphone sends the one or more frames of images and the inquiry speech information to the terminal device to obtain the reply speech information, the reply speech information is obtained by the terminal device inputting the one or more frames of images and inquiry speech information into the pre-trained dialogue model, and the reply speech information is sent by the terminal device to the earphone for playback.

17. The electronic device according to claim 14, wherein the pre-trained dialogue model is deployed at the cloud, and the earphone sends the one or more frames of images and the inquiry speech information to the dialogue model at the cloud for processing to obtain the reply speech information for playback.

18. The electronic device according to claim 14, wherein the pre-trained dialogue model comprises a multi-modal language model.

19. The electronic device according to claim 14, wherein the inquiry speech information is converted into text information and input to the pre-trained dialogue model.

20. The electronic device according to claim 14, wherein the reply speech information is information related to the one or more frames of images.
